(19) United States
(12) Patent Application Publication
(10) Pub. No.: US 2009/0025134 A1
(43) Pub. Date: Jan. 29, 2009

(54) Pool Cover Systems and Control Systems for Operating Mechanized Pool Cover Systems

(76) Inventor: Matthew Stephens, Cincinnati, OH (US)

Correspondence Address: ULMER & BERNE, LLP;ATTN: DIANE BELL, 600 VINE STREET, SUITE 2800, CINCINNATI, OH, 45202-2409, US

(21) Appl. No.: 11/828,148

(22) Filed: Jul. 25, 2007

(51) Int. Cl. E04H 4/10; G05B 15/02

(52) U.S. Cl. 4/498; 700/275

(57) ABSTRACT

A control system is configured for selectively facilitating operation of a mechanized pool cover system. The control system includes a security device and/or a sensor. A controller is in communication with the security device and/or sensor and is configured to selectively generate an actuation signal. A switch circuit is configured to facilitate provision of power from a power source to a pool cover actuator in response to receipt by the switch circuit of the actuation signal. The pool cover actuator is attached to a carriage, and the carriage is attached to a pool cover. The pool cover actuator is configured to selectively drive the carriage to facilitate movement of the pool cover with respect to a pool between a covering position and a non-covering position.

### TECHNICAL FIELD

A system is configured for selectively covering a pool. In one embodiment, a control system is configured for selectively facilitating operation of a mechanized pool cover system.

### BACKGROUND

Pool covers are often conventionally employed for protecting swimming pools from undesired access by persons, rainfall, and/or debris. Pool covers (e.g., solar-type covers) are also conventionally used in certain circumstances to selectively retain heat within the pool water. Many conventional swimming pool covers are installed and removed through a manual process of dragging the cover over a pool. However, some automated systems are conventionally available for selectively installing and removing a swimming pool cover. Such automated systems often involve use of a motorized spool to layout or take-up the cover, and are controlled through use of a key-type switch. This conventional arrangement requires an operator to keep track of a key. Loss of the key can present extreme inconvenience and resultant inability to operate the cover.

### SUMMARY

In accordance with one embodiment, a system is configured for selectively covering a pool. The system comprises a cover, a carriage, an actuator, a security device, a controller, and a switch circuit. The carriage is attached to the cover. The actuator is attached to the carriage and is configured to selectively drive the carriage to facilitate movement of the cover with respect to a pool between a covering position and a non-covering position. The security device comprises at least one of a keypad, a biometric sensor, a microphone, and a wireless receiver circuit. The controller is in communication with the security device and is configured to generate an actuation signal in response to a predetermined interface by an operator with the security device. The switch circuit is configured to facilitate provision of power from a power source to the actuator in response to receipt by the switch circuit of the actuation signal.

In accordance with another embodiment, a system is configured for selectively covering a pool. The system comprises a cover, a spool, an actuator, a keypad, a controller, and a switch circuit. The spool is attached to the cover. The actuator is attached to the spool and is configured to selectively drive the spool to facilitate movement of the cover with respect to a pool between a covering position and a non-covering position. The keypad has a plurality of keys, wherein at least some of said keys include symbolic indicia selected from the group consisting of alphanumeric indicia and numeric indicia. The controller is in communication with the keypad and is configured to generate an actuation signal in response to a predetermined sequence of contacts by an operator with at least one of said keys. The switch circuit is configured to facilitate provision of power from a power source to the actuator in response to receipt by the switch circuit of the actuation signal.

In accordance with yet another embodiment, a control system is configured for selectively facilitating operation of a mechanized pool cover system. The control system comprises a security device, a controller, and a switch circuit. The security device comprises at least one of a keypad, a biometric sensor, a microphone, and a wireless receiver circuit. The controller is in communication with the security device and is configured to generate an actuation signal in response to a predetermined interface by an operator with the security device. A switch circuit is configured to facilitate provision of power from a power source to a pool cover actuator in response to receipt by the switch circuit of the actuation signal.

In accordance with still another embodiment, a system is configured for selectively covering a pool. The system comprises a cover, a carriage, an actuator, a sensor, a controller, and a switch circuit. The carriage is attached to the cover. The actuator is attached to the carriage and is configured to selectively drive the carriage to facilitate movement of the cover with respect to a pool between a covering position and a non-covering position. The sensor is configured to detect the presence of a pool occupant and is configured to generate an occupation signal upon said detection. The controller is in communication with the sensor and is configured to selectively generate an actuation signal in response to the occupation signal. The switch circuit is configured to facilitate provision of power from a power source to the actuator in response to receipt by the switch circuit of the actuation signal.

In accordance with yet another embodiment, a control system is configured for selectively facilitating operation of a mechanized pool cover system. The control system comprises a sensor, a controller, and a switch circuit. The sensor is configured to detect the presence of a pool occupant and is configured to generate an occupation signal upon said detection. The controller is in communication with the sensor and is configured to selectively generate an actuation signal in response to the occupation signal. The switch circuit is configured to facilitate provision of power from a power source to a pool cover actuator in response to receipt by the switch circuit of the actuation signal.

### BRIEF DESCRIPTION OF THE DRAWINGS

It is believed that certain embodiments will be better understood from the following description taken in conjunction with the accompanying drawings in which:

FIG. 1 is a top perspective view depicting a pool having a pool cover system in accordance with one embodiment;

FIG. 2 is a front elevational view depicting a portion of the pedestal of FIG. 1;

FIG. 3 is a schematic block diagram depicting components of a housing having a security device in accordance with one embodiment;

FIG. 4 is a schematic block diagram depicting components of a control box in accordance with one embodiment; and

FIG. 5 is a top perspective view depicting a handheld remote control device in accordance with one embodiment.

### DETAILED DESCRIPTION

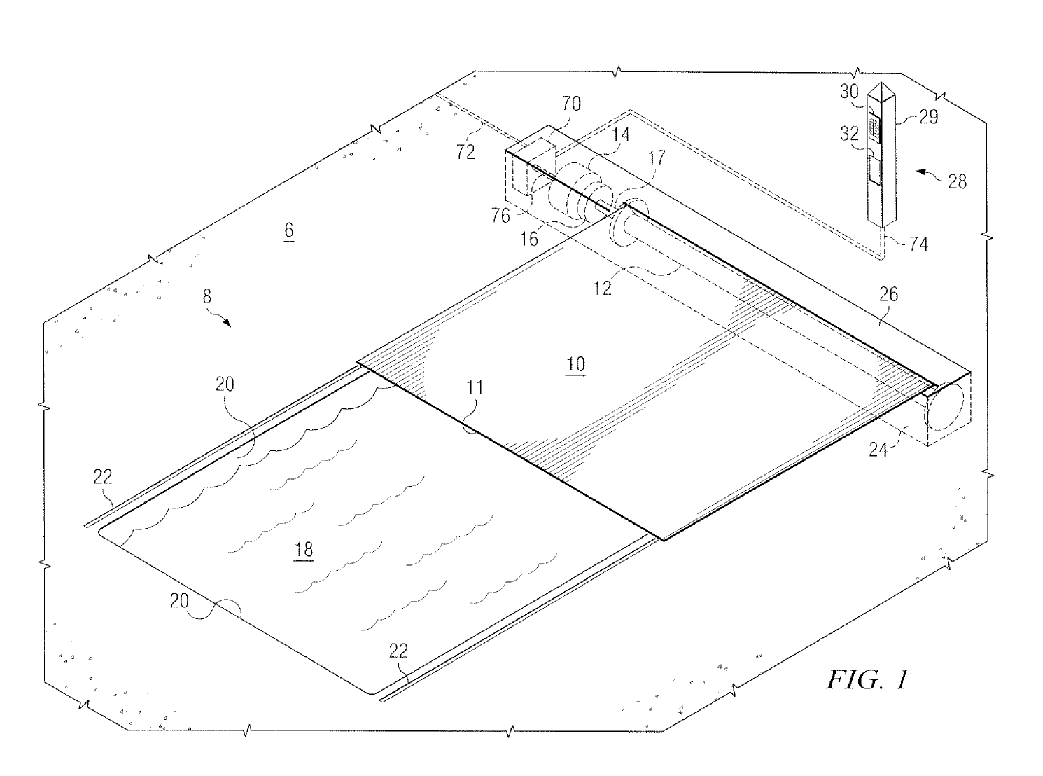

Embodiments are hereinafter described in detail in connection with the views and examples of FIGS. 1-5, wherein like numbers indicate the same or corresponding elements throughout the views. In accordance with one embodiment, with reference to FIG. 1, a system can be provided for selectively covering a pool 8 with a cover 10. While the pool 8 is shown to comprise a swimming-type pool, it will be appreciated that a system in accordance with other embodiments can be provided for use with other types of pools such as, for example, hot tubs, bathtubs, ponds, wells, industrial liquid reservoirs and tanks, and any of a variety of other applications. The cover 10 is shown to comprise a flexible material such as polypropylene, although any of a variety of other materials can alternatively be provided to form the cover. Also, while the cover 10 is shown to comprise a flexible material, it will be appreciated that a cover can alternatively comprise an assembly of substantially inflexible members (e.g., hingedly connected boards), or can even be formed as a single substantially inflexible member.

A carriage can be attached to a cover such as for selectively transporting and/or storing the cover to facilitate removal of the cover from the pool. In one embodiment, as shown in FIG. 1, the carriage comprises a spool 12 which is attached to the cover 10. The carriage can be positioned in any of a variety of suitable locations. For example, as shown in FIG. 1, the spool 12 can be disposed completely below-ground and within a well 24 covered by a removable lid 26. In this configuration, the lid 26 can be substantially flush with adjacent portions of a patio 6. In other embodiments, a spool might be provided above the surface of a patio, and either within or outside of an enclosure.

The spool 12 can be rotated to facilitate rolling of the cover 10 with respect to (i.e., onto and off from) the spool 12. It will be appreciated that the cover 10 can be rolled onto the spool 12 as the cover 10 is removed from the pool 8. Conversely, the cover 10 can be rolled off from the spool 12 when the cover 10 is applied to the pool 8. It will be appreciated that tracks 22 can be provided on both sides of the pool 8 to slidably retain a forward end 11 of the cover 10 during movement of the cover 10 with respect to the pool 8.

An actuator can be provided to facilitate rotation of the spool 12. In one embodiment, as shown in FIG. 1, the actuator can comprise an electric motor 14. However, in an alternative embodiment, the actuator can comprise a hydraulic or pneumatic motor. In still another embodiment, the actuator can comprise a linear actuator such as a hydraulic or pneumatic piston. In the example of FIG. 1, the electric motor 14 is shown to be coupled with a gearbox 16, wherein the gearbox 16 comprises a shaft 17 coupled with the spool 12. The electric motor 14 is accordingly configured to selectively rotate the spool 12 to facilitate rolling of the cover 10 with respect to the spool 12, and to provide resultant movement of the cover 10 with respect to the pool 8 between a covering position and a non-covering position. In an alternative embodiment, a gearbox might be provided in some other configuration or might not be provided at all.

A control box 70 is also shown in FIG. 1 as being disposed within the well 24. The control box 70 is shown to receive conduits 72, 74, and 76. The conduit 72 can be configured to provide power to the control box 70. In one embodiment, power wiring can be routed through the conduit 72 such as for conducting 120 V.A.C., 240 V.A.C., 12 V.D.C., 24 V.D.C., or any of a variety of other suitable electrical power sources. The conduit 76 can be configured for passage of electric power wiring from the control box 70 to the electric motor 14, as shown in FIG. 1. In another embodiment, hydraulic or pneumatic cables might additionally or alternatively be routed through the conduits 72 and 76. The conduit 74 can be configured for passage of control wiring and/or other communication lines or wiring to a security device and/or sensor(s) as discussed in further detail below. It will be appreciated that a control box can alternatively be disposed outside of the well 24 such as at a location remote from the patio 6. In this latter circumstance if a hydraulic or pneumatic actuator is employed, it will be appreciated that the system can be constructed without introduction of any electricity within the well 24 and/or otherwise in the vicinity of the pool 8 and/or patio 6.

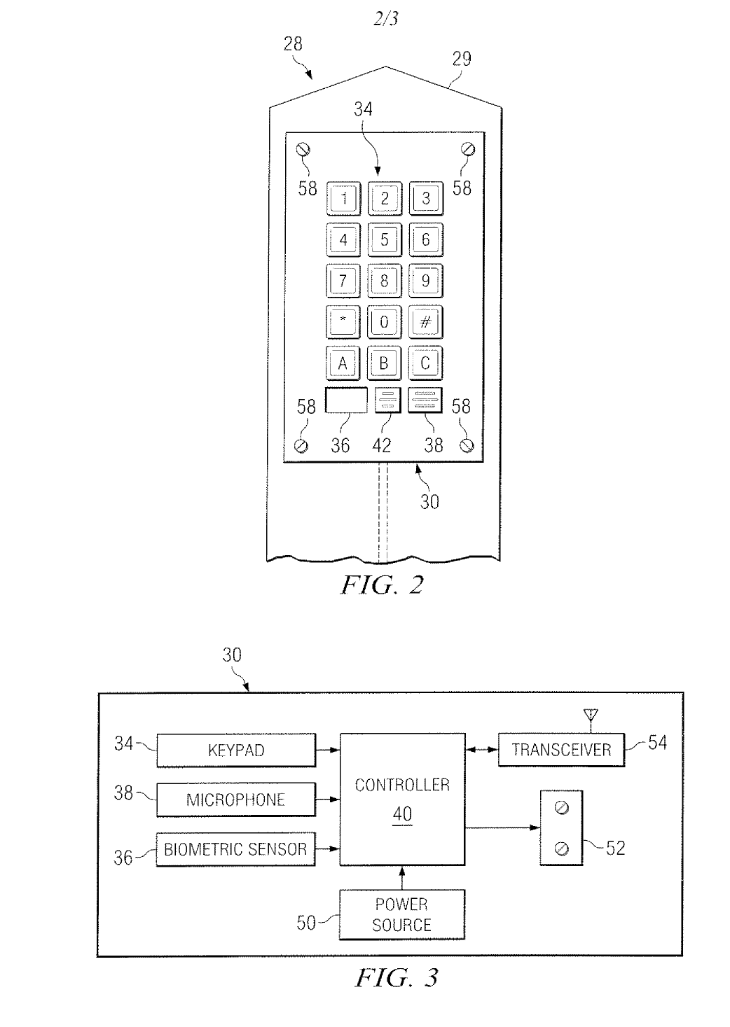

As shown in FIG. 1, a pedestal 28 can be provided on or near the patio 6. The pedestal 28 can comprise a post 29 which supports a housing 30 and/or one or more sensors (e.g., a motion sensor 32). The conduit 74 is shown to connect the pedestal 28 with the control box 70. FIG. 2 depicts an enlargement of a portion of the pedestal 28. In particular, the housing 30 is shown to be attached to the post 29 with screws 58 and to support security devices. A security device can comprise an actuator which facilitates operation of a system by designated users, but which does not facilitate operation of the system by non-designated users. For example, the security devices are shown in FIGS. 2-3 to include a keypad 34, a biometric sensor 36, a microphone 38, and a wireless transceiver circuit 54. It will be appreciated that the security devices can be configured to be resistant to sunlight and moisture. The housing and/or security device(s) can alternatively be provided in any of a variety of other configurations and might not be attached to a pedestal, but might rather be attached to a wall, a fence, a tree, or some other structure, or might even comprise a remote control device as discussed below.

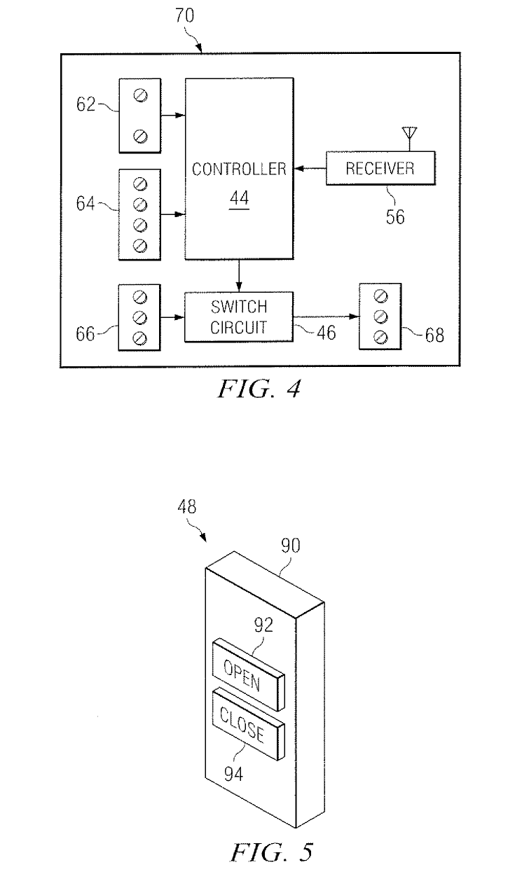

The wireless transceiver circuit 54 can include a wireless receiver circuit and a wireless transmitter circuit. The wireless transmitter circuit can be configured to communicate with a wireless receiver circuit (e.g., 56 in FIG. 4) within the well 24, thereby potentially avoiding any need for control wiring and/or communications lines extending from the well 24 to the pedestal 28, and thus potentially avoiding any need for the conduit 74. The wireless receiver circuit of the wireless transceiver circuit 54 can be configured for receiving a signal from a remote control device such as a handheld remote control device (e.g., 48 in FIG. 5), a telematics device, a mobile telephone, a personal computer, or the like. It will be appreciated that the wireless transceiver circuit 54 can be configured to communicate through use of optical (e.g., infrared), audible, radio frequency, and/or any of a variety of other types of communications. It will also be appreciated that an alternative security device might not include a wireless transceiver circuit, but may rather include only a wireless transmitter circuit or a wireless receiver circuit, or might alternatively not include any wireless circuits whatsoever.

Each of the keypad 34, the biometric sensor 36, the microphone 38, and the wireless transceiver circuit 54 can be provided in communication with a controller 40, as also shown in FIG. 3. The controller 40 can be configured to generate an actuation signal in response to a predetermined interface by an operator with at least one of the security devices. For example, if a security device comprises a keypad having a plurality of keys (e.g., 34 in FIG. 2), the controller can be configured to generate the actuation signal in response to a predetermined sequence of contacts by an operator with at least one of the keys. As another example, if a security device comprises a microphone (e.g., 38 in FIG. 2), the controller can be configured to generate the actuation signal in response to detection by the microphone of a particular voice and/or audible statement. As still another example, if a security device comprises a biometric sensor (e.g., 36 in FIG. 2), the controller can be configured to generate the actuation signal in response to detection by the biometric sensor of an operator's personal feature such as a fingerprint or retina. While the housing 30 is shown in FIGS. 2-3 to comprise four respective security devices, namely the keypad 34, the biometric sensor 36, the microphone 38, and the wireless transceiver circuit 54, it will be appreciated that systems in accordance with other embodiments might include fewer or greater than four security devices, and might perhaps include only a single security device. For example, in one particular embodiment, a system might comprise a keypad but might not comprise a biometric sensor, a microphone, or a wireless transceiver circuit 54.

When a system is provided to include a keypad as shown, for example, in FIG. 2, it will be appreciated that at least some of the keys of the keypad can include symbolic indicia selected from the group consisting of alphanumeric indicia (e.g., letters A-Z) and numeric indicia (e.g., numbers 0-9). Keys might additionally or alternatively include other symbolic indicia (e.g., *, #). It will be appreciated that the symbolic indicia present upon the keys of a keypad can assist an operator in remembering which keys to press, and in which sequence. A keypad can be constructed in any of a variety of mechanical configurations. For example, a keypad can be constructed as a pushbutton array in which multiple depress-type pushbuttons are arranged in an array. As another example, a keypad can be provided as a flat-panel type arrangement such as may be achieved through use of a touchscreen or capacitive panel.

It will be appreciated that an actuation signal can be conducted from the controller 40 to the control box 70 through use of wires. In such circumstance, the wires can attach to a connector 52 in the housing 30 and can lead (e.g., through the conduit 74 in FIG. 1) to the control box 70. These wires can also provide power to the controller 40 (e.g., to serve as the power source 50 shown in FIG. 3). In another embodiment, the actuation signal can be conducted wirelessly from the controller 40 to the control box 70, such as through transmission of the actuation signal by the transceiver 54 and reception of the actuation signal by the receiver 56 within the control box 70. In this configuration, a battery and/or solar cell might be provided as the power source 50 for the controller 40, as shown in FIG. 3.

When a security device comprises a wireless receiver circuit, a remote control device (e.g., 48 in FIG. 5) can be provided for use by an operator to remotely adjust the position of the cover 10. In particular, the remote control device can include an infrared or radio frequency transmitter which communicates an actuation signal to the wireless transceiver circuit 54 at the pedestal 28 and/or to the wireless receiver circuit 56 at the control box 70. The remote control device includes an actuator for use in accepting a command from an operator. In one embodiment, the actuator may itself comprise a keypad (e.g., similar to the keypad 34 of FIG. 2), a microphone, or a biometric sensor. However, in another embodiment, the actuator might alternatively comprise one or more switches or pushbuttons which are configured to accept simple commands from an operator. For example, in the embodiment of FIG. 5, the handheld remote control device 48 is shown to include two pushbuttons 92 and 94 provided within a housing 90. When an operator depresses the pushbutton 92, a wireless transmitter circuit within the handheld remote control device 48 can communicate with the wireless transceiver circuit 54 and/or the wireless receiver circuit 56 regarding removal of the cover 10 from the pool 8. Likewise, when an operator depresses the pushbutton 94, the wireless transmitter circuit within the handheld remote control device 48 can communicate with the wireless transceiver circuit 54 and/or the wireless receiver circuit 56 regarding application of the cover 10 upon the pool 8. In still another embodiment, the remote control device can comprise a conventional mobile telephone. For example, a security device in accordance with one embodiment can include a wireless receiver circuit which can receive transmissions from a mobile telephone and can communicate those transmissions to a controller such that actuation signals can correspondingly be generated for operating the cover. In this manner, an operator can use his or her mobile telephone to effect operation of the cover. In yet another embodiment, the remote control device may comprise a telematics unit which is controlled by a user or call center and which can communicate particular user-defined transmissions to effect operation of the cover.

The control box 70 can also include a switch circuit 46 and multiple connectors (e.g., 62, 64, 66, and 68), as shown in FIG. 4. In such circumstance where the housing 30 is wired to the control box 70 (e.g., as shown in FIG. 1 to involve the conduit 74), the actuation signal can be received into the control box 70 by way of wires attached to the connector 62. A power source can be attached to the connector 66 and can comprise, for example, 120 V.A.C., 240 V.A.C., 12 V.D.C., 24 V.D.C., or any of a variety of other suitable electrical power sources. The actuator (e.g., the electric motor 14 discussed above) can be attached to the connector 68 for receiving power from the control box 70. The switch circuit 46 can be configured to facilitate provision of power from the power source to the actuator in response to receipt by the switch circuit 46 of the actuation signal. In one embodiment, the switch circuit 46 can comprise at least one of a relay and a transistor to facilitate selective provision of power from the power source to the actuator.

In one embodiment, as shown in FIG. 4, the control box 70 might also include a controller 44. It can be seen that the controller 44 can communicate with the connectors 62 and 64 and with the receiver 56, and can accordingly communicate an actuation signal from any of these devices to the switch circuit 46. In an alternative embodiment, no such controller might be provided within the control box 70, but might only be provided at or near the security device (e.g., the controller 40 within the housing 30). In yet another embodiment, no controller might be provided near the security device, but might rather only be provided within the control box. It therefore will be appreciated that a system can include one or more controllers, and that the controller(s) can be provided in any of a variety of locations. It will be appreciated that a controller can comprise analog circuitry, a microprocessor, a field programmable gate array, a programmable logic controller (“PLC”), and/or other digital circuitry.

A system can also include one or more sensors which communicate with the controller. Such sensors can be wired to the connector 64 in the control box 70 as shown in FIG. 4, for example. In other embodiments, such sensors can communicate wirelessly with the wireless transceiver circuit 54 and/or the wireless receiver circuit 56. For example, a system in accordance with one embodiment might include one or more sensors which are configured to detect the presence of a pool occupant In particular, the motion sensor 32 is shown in FIG. 1 to be attached to the pedestal 28 and can be configured to detect motion near or in the pool 8. Upon detection of such motion, the motion sensor 32 can selectively generate an occupation signal, and can then communicate the occupation signal to a controller (e.g., 40 and/or 44). The controller can then selectively generate the actuation signal in response to the occupation signal. In particular, the controller can be configured to suppress the actuation signal upon detection of the occupation signal. In other words, when motion is detected by the motion sensor, the controller might thereafter prevent movement of the cover for a predetermined period of time. The controller can comprise a timer circuit which can assess passage of the predetermined period of time. In other embodiments, a motion sensor might be disposed elsewhere such as, for example, with reference to FIG. 1, beneath a water surface 18 of the pool 8 and/or on one or more side walls 20 of the pool 8. Other types of sensors (e.g., audible sensors, thermal sensors, light curtains, float valves) might additionally or alternatively be provided in communication with the controller to detect the presence of a pool occupant.

A system might additionally or alternatively include one or more temperature sensors (e.g., 42 in FIG. 2) which is/are configured to generate a temperature signal. The temperature sensor(s) can be positioned and configured to monitor the temperature of pool water and/or ambient air. The temperature sensor(s) can be provided in communication with the controller, and the controller can selectively generate the actuation signal in further response to the temperature signal. For example, in one embodiment, the controller can automatically generate the actuation signal for closing the cover over the pool if the temperature signals indicate that the temperature of the ambient air falls below the temperature of the water within the pool. In this manner, the system can function to assist in maintaining pool water temperature, and can therefore conserve energy costs by reducing the amount of water heating that might otherwise be provided or required to maintain the pool at a desired temperature.

Likewise, through use of a timer (e.g., as aforementioned), the system can be configured to automatically open or close the cover at certain times of the day. In this manner, the system can help to effectively regulate the temperature of the pool, but can also ensure that access to the pool is restricted during certain hours of the day. The system can also be configured to close the cover if the controller detects that the pool has not been used for some predetermined period of time. Accordingly, a system can be configured so as to ensure that a pool does not remain uncovered unnecessarily for an extended period of time. The system might also include one or more rainfall, wind, and/or humidity sensor(s) which communicate with the controller such that the cover might be automatically closed during rain to prevent carrying of leaves and debris into the pool. Accordingly, the system can reduce the frequency at which a pool must be cleaned.

It will be appreciated that the system can be configured such that it will not close the cover over the pool without first detecting whether anyone is present within the pool, and without perhaps additionally first generating a warning signal (e.g., a visible and/or audible signal) alerting that the cover is to be closed. Also, the system can be configured so as to automatically retract the cover upon detection of occupation of the pool (e.g., by detection of heat and/or noise beneath the cover when closed). Additionally, the system can be configured to detect the presence of persons or objects atop the cover when closed, and to prevent opening of the cover until the cover has been cleared of such persons or objects.

What has been described above includes examples. It is, of course, not possible to describe every conceivable combination of components or methodologies for purposes of describing the disclosed systems and methods, but one of ordinary skill in the art may recognize that many further combinations and permutations are possible. Accordingly, the disclosed systems and methods are intended to embrace all such alterations, modifications, and variations.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used, these terms are intended to be inclusive in a manner similar to the term “comprising.”

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

1-20. (canceled)

21. A system configured for selectively covering a pool, the system comprising:
a cover;
a carriage attached to the cover;
an actuator attached to the carriage and configured to selectively drive the carriage to facilitate movement of the cover with respect to a pool between a covering position and a non-covering position;
a biometric sensor;
a controller in communication with the biometric sensor and configured to generate an actuation signal in response to a predetermined interface by an operator with the biometric sensor; and
a switch circuit configured to facilitate provision of power from a power source to the actuator in response to receipt by the switch circuit of the actuation signal.

22. The system of claim 21 wherein the carriage comprises a spool, the actuator comprises a motor, and the motor is configured to selectively rotate the spool to facilitate rolling of the cover with respect to the spool.

23. The system of claim 21 further comprising a sensor configured to detect presence of a pool occupant and to selectively generate an occupation signal, wherein the sensor communicates the occupation signal to the controller, and the controller is configured to suppress the actuation signal upon detection of the occupation signal.

24. The system of claim 21 wherein the controller is configured to generate the actuation signal in response to detection by the biometric sensor of an operator's fingerprint.

25. The system of claim 21 wherein the controller is configured to generate the actuation signal in response to detection by the biometric sensor of an operator's retina.

26. The system of claim 21 further comprising a temperature sensor configured to generate a temperature signal, wherein:
the temperature sensor is configured to monitor at least one of pool water and ambient air;
the temperature sensor is in communication with the controller; and
the controller is configured to selectively generate the actuation signal in further response to the temperature signal.

27. A control system configured for selectively facilitating operation of a mechanized pool cover system, the control system comprising:
a biometric sensor;
a controller in communication with the biometric sensor and configured to generate an actuation signal in response to a predetermined interface by an operator with the biometric sensor; and
a switch circuit configured to facilitate provision of power from a power source to a pool cover actuator in response to receipt by the switch circuit of the actuation signal.

28. The control system of claim 27 further comprising a sensor configured to detect presence of a pool occupant and to selectively generate an occupation signal, wherein the sensor communicates the occupation signal to the controller, and the controller is configured to suppress the actuation signal upon detection of the occupation signal.

29. The control system of claim 27 further comprising a temperature sensor configured to generate a temperature signal, wherein:
the temperature sensor is configured to monitor at least one of pool water and ambient air;
the temperature sensor is in communication with the controller; and
the controller is configured to selectively generate the actuation signal in further response to the temperature signal.

30. The control system of claim 27 wherein the controller is configured to generate the actuation signal in response to detection by the biometric sensor of an operator's fingerprint.

31. The control system of claim 27 wherein the controller is configured to generate the actuation signal in response to detection by the biometric sensor of an operator's retina.

32. A system configured for selectively covering a pool, the system comprising:
a cover;
a carriage attached to the cover;
an actuator attached to the carriage and configured to selectively drive the carriage to facilitate movement of the cover with respect to a pool between a covering position and a non-covering position;
a microphone;
a controller in communication with the microphone and configured to generate an actuation signal in response to a predetermined interface by an operator with the microphone; and
a switch circuit configured to facilitate provision of power from a power source to the actuator in response to receipt by the switch circuit of the actuation signal.

33. The system of claim 32 wherein the carriage comprises a spool, the actuator comprises a motor, and the motor is configured to selectively rotate the spool to facilitate rolling of the cover with respect to the spool.

34. The system of claim 32 further comprising a sensor configured to detect presence of a pool occupant and to selectively generate an occupation signal, wherein the sensor communicates the occupation signal to the controller, and the controller is configured to suppress the actuation signal upon detection of the occupation signal.

35. The system of claim 32 further comprising a temperature sensor configured to generate a temperature signal, wherein:
the temperature sensor is configured to monitor at least one of pool water and ambient air;
the temperature sensor is in communication with the controller; and
the controller is configured to selectively generate the actuation signal in further response to the temperature signal.

36. A control system configured for selectively facilitating operation of a mechanized pool cover system, the control system comprising:
a microphone;
a controller in communication with the microphone and configured to generate an actuation signal in response to a predetermined interface by an operator with the microphone; and
a switch circuit configured to facilitate provision of power from a power source to a pool cover actuator in response to receipt by the switch circuit of the actuation signal.

37. The control system of claim 36 further comprising a sensor configured to detect presence of a pool occupant and to selectively generate an occupation signal, wherein the sensor communicates the occupation signal to the controller, and the controller is configured to suppress the actuation signal upon detection of the occupation signal.

38. The control system of claim 36 further comprising a temperature sensor configured to generate a temperature signal, wherein:
the temperature sensor is configured to monitor at least one of pool water and ambient air;
the temperature sensor is in communication with the controller; and
the controller is configured to selectively generate the actuation signal in further response to the temperature signal.

39. A system configured for selectively covering a pool, the system comprising:
a cover;
a carriage attached to the cover;
an actuator attached to the carriage and configured to selectively drive the carriage to facilitate movement of the cover with respect to a pool between a covering position and a non-covering position;
a wireless receiver circuit configured to receive transmissions from a mobile telephone;
a controller in communication with the wireless receiver circuit and configured to generate an actuation signal in response to a predetermined interface by an operator with the wireless receiver circuit; and
a switch circuit configured to facilitate provision of power from a power source to the actuator in response to receipt by the switch circuit of the actuation signal.

40. The system of claim 39 wherein the carriage comprises a spool, the actuator comprises a motor, and the motor is configured to selectively rotate the spool to facilitate rolling of the cover with respect to the spool.

41. The system of claim 39 further comprising a sensor configured to detect presence of a pool occupant and to selectively generate an occupation signal, wherein the sensor communicates the occupation signal to the controller, and the controller is configured to suppress the actuation signal upon detection of the occupation signal.

42. The system of claim 39 further comprising a temperature sensor configured to generate a temperature signal, wherein:
the temperature sensor is configured to monitor at least one of pool water and ambient air;
the temperature sensor is in communication with the controller; and
the controller is configured to selectively generate the actuation signal in further response to the temperature signal.

43. A control system configured for selectively facilitating operation of a mechanized pool cover system, the control system comprising:
a wireless receiver circuit configured to receive transmissions from a mobile telephone;
a controller in communication with the wireless receiver circuit and configured to generate an actuation signal in response to a predetermined interface by an operator with the wireless receiver circuit; and
a switch circuit configured to facilitate provision of power from a power source to a pool cover actuator in response to receipt by the switch circuit of the actuation signal.

44. The control system of claim 43 further comprising a sensor configured to detect presence of a pool occupant and to selectively generate an occupation signal, wherein the sensor communicates the occupation signal to the controller, and the controller is configured to suppress the actuation signal upon detection of the occupation signal.

45. The control system of claim 43 further comprising a temperature sensor configured to generate a temperature signal, wherein:
the temperature sensor is configured to monitor at least one of pool water and ambient air;
the temperature sensor is in communication with the controller; and
the controller is configured to selectively generate the actuation signal in further response to the temperature signal.

46. A system configured for selectively covering a pool, the system comprising:
a cover;
a carriage attached to the cover;
an actuator attached to the carriage and configured to selectively drive the carriage to facilitate movement of the cover with respect to a pool between a covering position and a non-covering position;
a sensor configured to detect the presence of at least one of rainfall, wind, and humidity and further configured to generate an environmental signal upon said detection;
a controller in communication with the sensor and configured to selectively generate an actuation signal in response to the environmental signal; and
a switch circuit configured to facilitate provision of power from a power source to the actuator in response to receipt by the switch circuit of the actuation signal.

47. The system of claim 46 being configured to automatically move the cover to the covering position when rain is detected or predicted by the controller in response to receipt by the controller of the environmental signal from the sensor.

48. A control system configured for selectively facilitating operation of a mechanized pool cover system, the control system comprising:
a sensor configured to detect the presence of at least one of rainfall, wind, and humidity and further configured to generate an environmental signal upon said detection;
a controller in communication with the sensor and configured to selectively generate an actuation signal in response to the environmental signal; and
a switch circuit configured to facilitate provision of power from a power source to a pool cover actuator in response to receipt by the switch circuit of the actuation signal.
